(19) United States
(12) Patent Application Publication
(10) Pub. No.: US 2025/0257590 A1
(43) Pub. Date: Aug. 14, 2025

(54) LOCKING MECHANISM

(71) Applicant: ARMORGARD HOLDINGS LIMITED, Fareham Hampshire (GB)

(72) Inventors: Paul John GARDNER, Fareham (GB); Thomas Eliot HAYWARD, Fareham (GB); Oliver Samuel MURRAY, Fareham (GB); Matthew PARTRIDGE, Fareham (GB)

(73) Assignee: ARMORGARD HOLDINGS LIMITED, Fareham Hampshire (GB)

(21) Appl. No.: 19/051,737

(22) Filed: Feb. 12, 2025

Related U.S. Application Data
(63) Continuation of application No. PCT/GB2023/051463, filed on Jun. 5, 2023.

(30) Foreign Application Priority Data
Aug. 15, 2022 (GB) 2211899.6

(51) Int. Cl. E05B 65/52

(52) U.S. Cl. CPC E05B 65/5284; E05B 65/5246

(57) ABSTRACT

A locking mechanism is disclosed. The locking mechanism has a rotatable member configured to rotate about its longitudinal axis, at least one primary engaging member fixed to the rotatable member and configured to rotate about the longitudinal axis of the rotatable member, at least one retainable member configured to be retained by the at least one primary engaging member and a blocking member receiving portion located adjacent to the at least one primary engaging member and is configured to receive the blocking member when the locking mechanism is in an engaged configuration. When the blocking member is received in the blocking member receiving portion, rotation of the at least one primary engaging member about the longitudinal axis of the rotatable member is inhibited and the at least one retainable member is retained by the at least one primary engaging member. Also disclosed is a container having a locking mechanism.

### CROSS REFERENCE TO RELATED APPLICATIONS

This continuation application claims priority benefit from International Application No. PCT/GB2023/051463 filed on Jun. 5, 2023, which claimed priority from Great Britain Application No. 2211899.6 filed Aug. 15, 2022, which are both incorporated herein by reference in their entirety.

### FIELD OF THE INVENTION

The present invention relates to a locking mechanism for a container. The present invention also relates to a container comprising a locking mechanism.

### BACKGROUND OF THE INVENTION

Typically, a mortice lock is used to fasten a door, a cabinet or a container, such as a toolbox, such that the contents of the container cannot be accessed without the corresponding key.

Security of the container to be locked is crucial to prevent unauthorised access to its contents.

However, complex locking mechanisms requiring multiple user inputs to lock the door or container can be difficult to use and require more user time to operate. Additionally, such locking mechanisms lack compatibility with standard locking devices owned by the user.

Objects and aspects of the present claimed invention seek to alleviate at least these noted problems as disclosed by the prior art.

### SUMMARY OF THE INVENTION

According to a first aspect of the invention, there is provided a locking mechanism for a container, the locking mechanism comprising; a rotatable member configured to rotate about its longitudinal axis; at least one primary engaging member fixed to the rotatable member and configured to rotate about the longitudinal axis of the rotatable member; at least one retainable member configured to be retained by the at least one primary engaging member when the locking mechanism is in an engaged configuration; and a blocking member receiving portion located adjacent the at least one primary engaging member and configured to receive a blocking member when the locking mechanism is in an engaged configuration, wherein when a blocking member is received in the blocking member receiving portion, rotation of the at least one primary engaging member about the longitudinal axis of the rotatable member is inhibited and the at least one retainable member is retained by the at least one primary engaging member.

In this way, there is provided a secure locking mechanism with improved ease of operation. Advantageously, a single actuation point can be provided thereby increasing the ease and speed with which a user can unlock and lock an object fitted with the locking mechanism, such as a container. A blocking member of any suitable type can be provided by the user, allowing the user to select the most appropriate lock for the application. Further, the user can replace or change the blocking member as desired, such as to replace old or damaged padlocks or employ a combination lock with a new unlocking code.

Additionally, the user is not required to undertake a complex series of actions to actuate the locking mechanism. Instead, the user locks or unlocks the blocking member received on the blocking member receiving portion to secure or release the object fitted with the locking mechanism.

Preferably, the at least one primary engaging member comprises a plurality of projections, wherein any one of the plurality of projections is configured to retain the at least one retainable member when the locking member is in the engaged configuration. In this way, as the rotatable member rotates, the angle of rotation required before the at least one retainable member is retained by a projection of the at least one primary engaging member is reduced. Namely, a smaller rotation of the rotatable member is not required for the at least one retainable member to engage with a projection and become retained by the at least one primary engaging member.

The engaged configuration is understood to be the configuration wherein the locking member is ready to receive a blocking member such that when the blocking member is received on the blocking member receiving portion, the locking mechanism prevents opening of the container.

In some embodiments, the plurality of projections comprises two projections. More preferably, the plurality of projections comprises at least three projections. Alternatively, the plurality of projections comprises at least six projections.

Preferably, the blocking member receiving portion is configured to receive at least one of; a padlock, a combination lock or a deadbolt of a mortice lock. In embodiments where the blocking member receiving portion is configured to receive a deadbolt of a mortice lock, the blocking member receiving portion comprises a guide plate for guiding the deadbolt into abutment with the at least one primary engaging member. In embodiments where the blocking member receiving portion is configured to receive a deadbolt of a mortice lock, the locking mechanism comprises a mortice lock unit comprising a deadbolt.

In embodiments where the blocking member receiving portion is configured to receive a padlock or a combination lock, the blocking member receiving portion comprises a receiving bar with a longitudinal axis parallel to the longitudinal axis of the rotatable member. In this way, both the longitudinal axis of the rotatable member and the receiving bar are parallel to the ground, in use. Such a configuration is envisaged to be particularly advantageous when the locking mechanism is provided in a ‘single door application’, such as on a box with a single lid or on a container with a single door.

Alternatively, the blocking member receiving portion comprises a receiving bar with a longitudinal axis perpendicular to the longitudinal axis of the rotatable member. In this way, the longitudinal axis of the rotatable member is perpendicular to the ground and the receiving bar is parallel to the ground. Such a configuration is envisaged to be particularly advantageous when the locking mechanism is provided in a ‘two door application’, such as on a cabinet.

In some embodiments, the at least one primary engaging member comprises a pair of primary engaging members spaced from each other along the rotatable member. Preferably, the spacing of the pair of primary engaging members along the rotatable member is from 2 mm to 30 mm. More preferably, the spacing of the pair of primary engaging members along the rotatable member is from 5 mm to 20 mm. Preferably, the pair of primary engaging members are a mirrored pair.

Preferably, the at least one retainable member comprises a plurality of retainable members and the locking mechanism further comprises at least one secondary engaging member fixed to the rotatable member and configured to rotate about the longitudinal axis of the rotatable member, the at least one secondary engaging member configured to engage the at least one retainable member when the locking mechanism is in an engaged configuration.

In some embodiments, the at least one secondary engaging member comprises a symmetrical cam. In some embodiments, the at least one secondary engaging member is identical to the at least one primary engagement member.

In some embodiments, the at least one retainable member comprises three, five or seven retainable members. Preferably, the at least one retainable member comprises three retainable members. Preferably, the at least one retainable member comprises a first retainable member located at a first end of the locking mechanism and a second retainable member located at a second end of the locking mechanism. Preferably, the at least one retainable member further comprises a central retainable member located at the midpoint of the locking mechanism. In this way, retainable members are equally spaced along the locking mechanism and substantially uniform security is provided along the length of the locking mechanism. It is understood that a greater number of retainable members may be more appropriate for applications wherein the rotatable member is longer or when increased security is desired.

Preferably, the number of at least one secondary engaging members is equal to n−1 the number of at least one retainable members. Preferably, the central retainable member is configured to be retained by the at least one primary engaging member when the locking mechanism is in an engaged configuration. Preferably, the first retainable member and second retainable member are configured to be retained by the at least one secondary engaging member when the locking mechanism is in an engaged configuration.

In select embodiments, the locking mechanism comprises at least one secondary blocking member receiving portion located adjacent the at least one secondary engaging member and configured to receive a blocking member when the locking mechanism is in an engaged configuration. In this way, a multi-point locking mechanism is provided. It is understood that this configuration is undesirable in applications wherein the user wishes to reduce the time spent engaging with the locking mechanism.

Preferably, the at least one primary engaging member is configured to rotate in a retaining direction and in an opposing releasing direction, wherein in the retaining direction the at least one primary engaging member is urged further into engagement with the at least one retainable member and in the opposing releasing direction the at least one primary engaging member is urged out of engagement with the at least one retainable member; wherein when the locking mechanism is moved from a disengaged position to the engaged position, the at least one retainable member urges the at least one primary engaging member in the retaining direction and when the locking mechanism is moved from the engaged position into the disengaged position, the at least one retainable member urges the at least one primary engaging member in the releasing direction. For example, the retaining direction may be clockwise about the rotatable member and the opposing releasing direction may be anticlockwise about the rotatable member or vice versa.

It is envisaged that the force urging the at least one primary engaging member to rotate in the retaining direction and/or the releasing direction may be a user force coupled to the at least one retainable member. In some embodiments, the at least one retainable member is fixed to the lid of a container and when the user lowers the lid the at least one primary engaging member is urged further into engagement with the at least one retainable member. Additionally, when the user raises the lid of a container, the at least one primary engaging member is urged out of engagement with the at least one retainable member.

In another embodiment, the at least one retainable member is fixed to the doors of a container and when the user closes the doors, the at least one primary engaging member is urged further into engagement with the at least one retainable member. Additionally, when the user opens the doors of the container, the at least one primary engaging member is urged out of engagement with the at least one retainable member.

In some embodiments, the plurality of projections are uniformly spaced about the at least one primary engaging member. In some embodiments, the at least one primary engaging member is rowel shaped. Alternatively, the plurality of projections are a plurality of hooks. In some embodiments, the plurality of projections are curved projections. Preferably, the plurality of curved projections are identical and project in either the retaining direction or the releasing direction, when fixed to the rotatable member. In some embodiments, the at least one primary engaging member is snowflake shaped. In some embodiments, each projection of the plurality of projections is snail shaped. Namely, each projection comprises a straight edge connected to a curved edge.

Preferably, each projection of the plurality of projections comprises an abutting portion complementary to a portion of the at least one retainable member and configured to abut the at least one retainable member when the locking mechanism is in an engaged configuration. In this way, the abutting portion aids retention of the at least one retainable member in the at least one primary engaging member. In some embodiments, the abutting portion comprises a groove complementary to a blocking member. In some embodiments, the abutting portion comprises a groove complementary to the at least one retainable member. In some embodiments, the abutting portion comprises a slot complementary to the at least one retainable member. In some embodiments, the abutting portion comprises a flat surface configured to abut a blocking member mounted to the blocking member receiving portion.

Preferably, the rotatable member is fixed in the direction of the longitudinal axis. Namely, the rotatable member can rotate about its longitudinal axis but is not configured to slide in either direction parallel to the longitudinal axis.

According to a second aspect of the invention, there is provided a container comprising the locking mechanism of the first aspect of the present invention.

Preferably, the container is one of the following: a box such as a chest, storage box, site box or toolbox; a piano box; a cabinet; a cupboard; a shipping container; a hazardous goods store; a walk-in storage container; or a room such that the locking mechanism locks an opening to the room.

Preferably, the at least one retainable member is located in a first area of the container and the at least one primary engaging member is located in a second area of the container. Preferably, the first area of the container is one of; a lid, a door or a pair of doors. Preferably, the second area of the container is the container body comprising an enclosable volume for storing the contents of the container.

Preferably, the second area of the container comprises at least one retainable member guide configured to guide the at least one retainable member into the second area of the container when the at least one primary engaging member is urged further into engagement with the at least one retainable member.

Preferably, the elongate member is located parallel to a free edge of the second area. For example, the elongate member may be located parallel to the free edge of the container door or lid. In this way, the at least one primary engagement member is configured to rotate towards and away from the free edge of the container, in the retaining and releasing directions.

Preferably, the container comprises a guiding aperture configured to guide the blocking member onto the receiving bar. Further, access to the blocking member receiving portion is provided by the guiding aperture. Preferably, the guiding aperture is located on a front face of the container. For example, the front face may be the front face of the body of a container or the doors of the container.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1 depicts a front view of a first embodiment of a locking mechanism according to the first aspect of the invention, the locking mechanism shown in the engaged position, in accordance with an aspect of the present disclosure;

FIG. 2 depicts a perspective view of the locking mechanism of FIG. 1, the locking mechanism shown in a disengaged position, in accordance with an aspect of the present disclosure;

FIG. 3 depicts a further perspective view of the locking mechanism of FIG. 1, the locking mechanism shown in a disengaged position, in accordance with an aspect of the present disclosure;

FIG. 4A depicts a side view of the locking mechanism of FIG. 1, the locking member shown in a disengaged position, in accordance with an aspect of the present disclosure;

FIGS. 4B and 4C depict a side view of the locking mechanism of FIG. 1, the locking mechanism shown being urged from a disengaged position to the engaged position, in accordance with an aspect of the present disclosure;

FIG. 4D depicts a side view of the locking mechanism of FIG. 1, the locking member shown in the engaged position, in accordance with an aspect of the present disclosure;

FIG. 5 depicts a perspective view of the primary engaging member of FIG. 1, in accordance with an aspect of the present disclosure;

FIG. 6 depicts a perspective view of a second embodiment of a locking mechanism in accordance with the first aspect of the present invention, the locking mechanism comprising a mortice lock, in accordance with an aspect of the present disclosure;

FIG. 7 depicts a perspective view of a third embodiment of the locking mechanism of the first aspect of the present invention, in accordance with an aspect of the present disclosure;

FIG. 8 depicts a perspective view of the pair of rotatable members of the locking mechanism of FIG. 7, in accordance with an aspect of the present disclosure;

FIG. 9A depicts a top view of the locking mechanism of FIG. 7, the locking mechanism being in a disengaged configuration, in accordance with an aspect of the present disclosure;

FIG. 9B depicts a top view of the locking mechanism of FIG. 7, the locking mechanism is in the engaged configuration, in accordance with an aspect of the present disclosure; and

FIGS. 10-15 depict various alternative embodiments of the primary engagement member of the locking mechanism of FIGS. 1 to 9B, in accordance with an aspect of the present disclosure.

### DETAILED DESCRIPTION FOR CARRYING OUT THE INVENTION

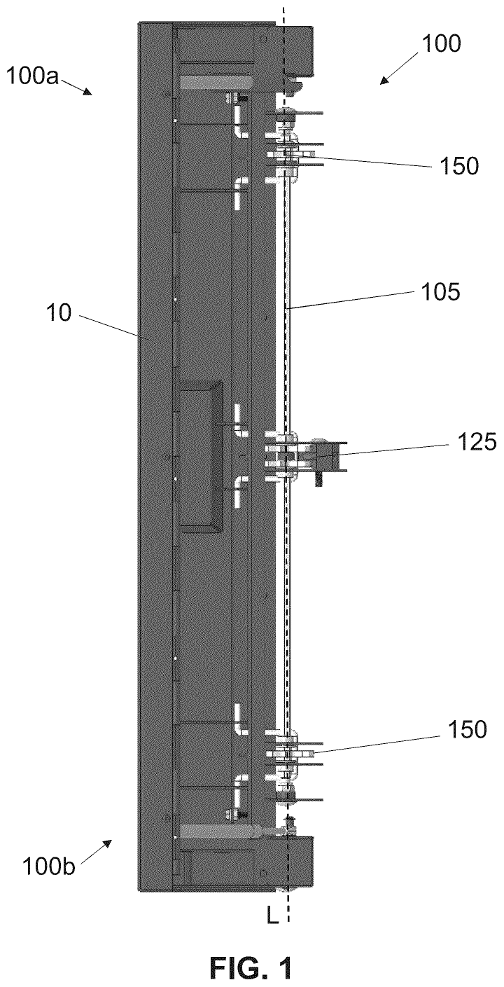

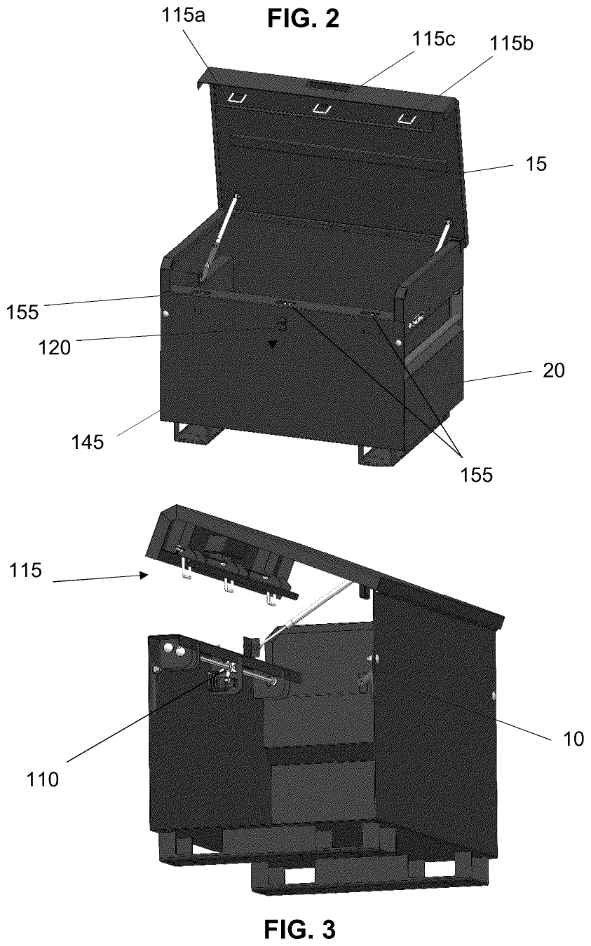

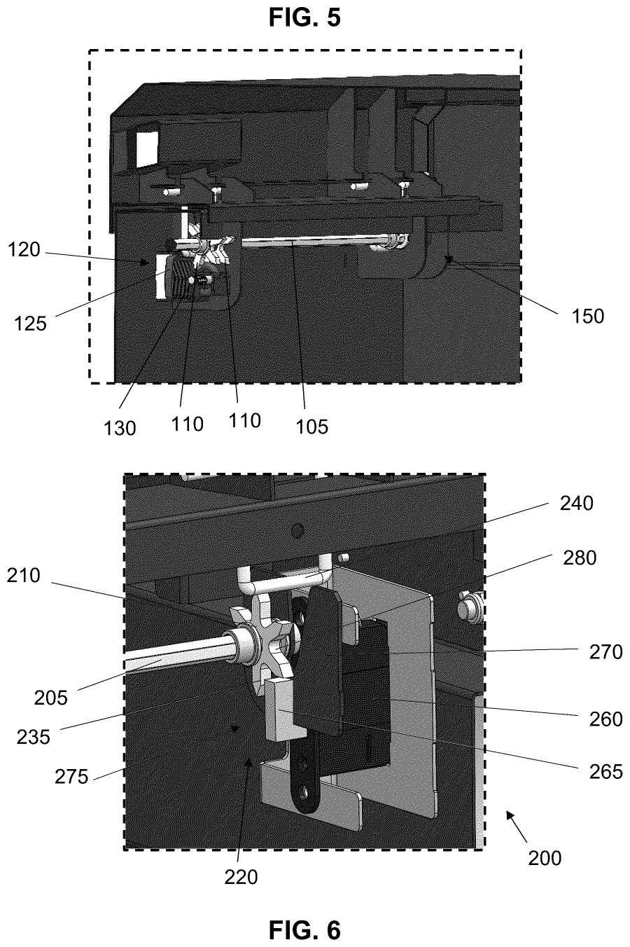

With reference to FIGS. 1-5, a first embodiment of a locking mechanism 100, in accordance with the first aspect of the invention, fitted to a container 10 is illustrated. In this first embodiment, the locking mechanism 100 is shown in a ‘single door application’ wherein the container 10 comprises a single lid 15 and a container body 20 comprising an enclosable volume for storing the contents of the container 10. In this embodiment, the container 10 is a site storage box. The lid 15 is configured to be opened and closed in the standard manner, wherein when the lid 15 is closed, a portion of the lid 15 abuts the container body 20.

The locking mechanism 100 comprises an elongate rotatable member 105 comprising a rod with a hexagonal cross-section. The rotatable member 105 is configured to rotate in both directions about its longitudinal axis L.

The locking mechanism 100 further comprises a pair of primary engaging members 110 fixed to the rotatable member 105 and configured to rotate about the longitudinal axis L of the rotatable member 105. The pair of primary engaging members 110 are spaced from each other along the rotatable member 105 such that there is a gap between them.

The locking mechanism 100 further comprises three retainable members 115 comprising a first retainable member 115a, a second retainable member 115b and a central retainable member 115c. The first retainable member 105a is located at a first end 100a of the locking mechanism 100, the second retainable member 105b is located at a second end 100b of the locking mechanism 100 and the central retainable member 105a is located at the midpoint between the first end 105a and second end 105b. The three retainable members 115 are located on the free edge of the lid 15 of the container 10.

The central retainable member 115c is configured to be retained by the pair of primary engaging members 110 when the locking mechanism 100 is in an engaged configuration.

The locking mechanism 100 further comprises a blocking member receiving portion 120 located adjacent the pair of primary engaging members 110. The blocking member receiving portion 120 is configured to receive a blocking member, such as a padlock 125, when the locking mechanism 100 is in an engaged configuration. In this way, the blocking member receiving portion 120, and subsequently the padlock 125, are located centrally on the locking mechanism 100, improving access to the padlock 125. The blocking member receiving portion 120 comprises a cylindrical receiving bar 130 with a longitudinal axis parallel to the longitudinal axis L of the rotatable member 105. The cylindrical receiving bar 130 is fixed to the container body 20 of the container 10 and has a diameter less than the gap between the shackle and body of the padlock 125, such that the padlock 125 can be hooked onto, and thereby retained on, the receiving bar 130 with a clearance fit.

When the locking mechanism 100 is in the engaged configuration, the pair of primary engaging members 110 are located between the central retainable member 115c and the receiving bar 120.

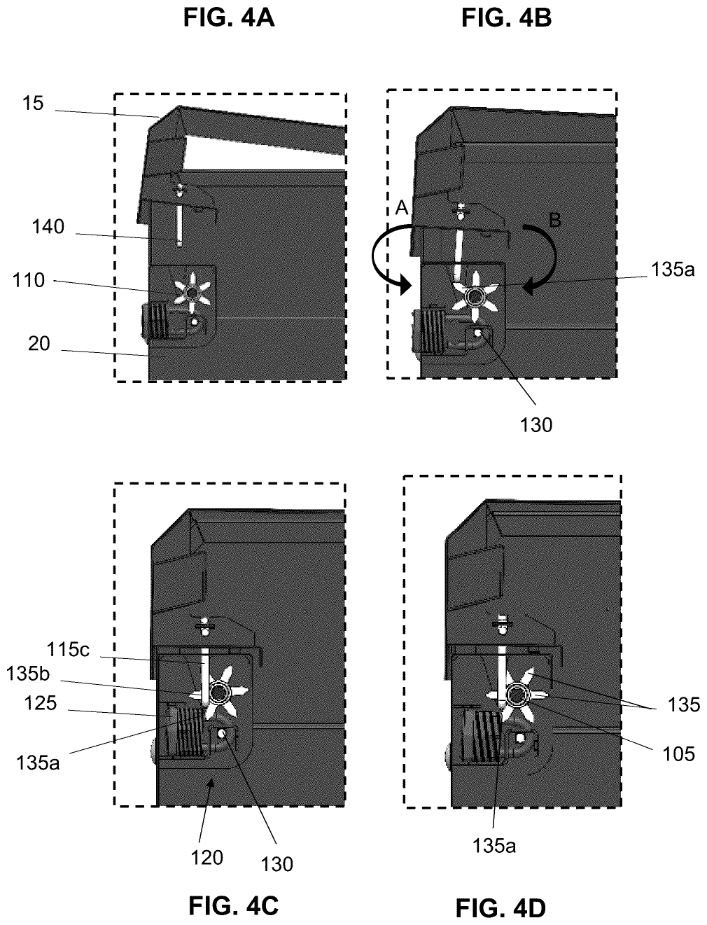

Each primary engaging member 110 comprises six projections 135 uniformly spaced about the primary engaging member 110 such that each primary engaging member 110 is rowel shaped. The pair of primary engaging members 110 are an identical, mirrored pair and are fixed to the rotatable member 105 such that each projection 135 of a primary engaging member 110 is aligned with a corresponding projection 135 on the other primary engaging member 110. In this way, when looking along the longitudinal axis L of the rotatable member 105 at the pair of primary engaging members 110, the distal primary engaging member 110 is obscured behind the proximal primary engaging member 110, as illustrated in FIG. 4.

Each of the six projections 135 comprises an abutting portion complementary to an abutting end 140 of the central retainable member 115c and configured to abut the abutting end 140 of the central retainable member 115c when the locking mechanism 100 is in an engaged configuration. Each abutting portion comprises a depression complementary to the abutting end 140 of the central retainable member 115c.

The pair of primary engaging members 110 are configured to rotate in a retaining direction A and in an opposing releasing direction B about the longitudinal axis L of the rotatable member 105. In FIGS. 4A-4D, the retaining direction A is anti-clockwise and the releasing direction B is clockwise. In retaining direction A, the pair of primary engaging members 110 are urged further into engagement with central retainable member 115c. In the releasing direction B the pair of primary engaging members 110 are urged out of engagement with the central retainable member 115c.

As illustrated in FIGS. 4A-4D, the user can move the lid 15 from an open to a closed position against the container body 20. The action of closing the lid 15 brings the abutting end 140 of the central retainable member 115c into contact with a first projection 135a of each of the pair of primary engaging members 110, illustrated in FIG. 4B. The central retainable member 115c provides a force to these first projections 135a such that the pair of primary engaging members 110 and the rotatable member 105 are urged to rotate in the retaining direction A.

Located adjacent to the first projection 135a, in the releasing direction B, is a second projection 135b. As the pair of primary engaging members 110 are urged in the retaining direction A, the second projection 135b abuts the abutting end 140 of the central retainable member 115c. When the lid 15 is fully closed against the body, as illustrated in FIG. 4C, the central retainable member 115c is located in the abutting portion of the first projection 135a and the second projection 135b.

The pair of primary engaging members 110 are spaced apart such that the shackle of the padlock 125 can be located on the receiving bar 130 between the pair of primary engaging members 110. The user is guided by a guiding aperture 145 located in the front wall of the container 10, the guiding aperture 145 guiding the shank of the padlock 125 to a position between the pair of primary engaging members 110. In this way, rotation of the pair of primary engaging members 110 and rotatable member 105 is not inhibited by the shackle of the padlock 125 when the shackle is retained on the receiving bar 130, as illustrated in FIGS. 4A and 4B. When the lid 15 is shut, the user can close and lock the padlock 125, thereby bringing the body of the padlock 125 towards the shackle. It is understood that other blocking members may not comprise an extending and contracting function, and therefore the user would only attach the blocking member to the blocking member receiving portion 120 after the lid 15 of the container 10 was closed if they wished to lock the container 10.

The locking mechanism 100 is located within a casing of the container 10 such that when the locking mechanism 100 is in the engaged position, access to the locking mechanism 100 is restricted to the guiding aperture 145 only.

When the padlock 125 is closed on the receiving bar 130, rotation of the primary engaging members 110 and rotatable member 105 in the releasing direction B is inhibited. As illustrated in FIG. 4D, the first projection 135a abuts the body of the padlock 125 and when the user attempts to open the lid 15 of the container 10, rotation of the primary engaging members 110 is inhibited.

Abutment of the first projection 135a against the padlock 125 provides a force inhibiting opening of the lid 15 of the container 10. Removal of the padlock 125 from the receiving bar 130 is inhibited without first unlocking the padlock 125. As such, unauthorised access to the contents of the container 10 is inhibited when the locking mechanism 100 is in the engaged position and the padlock 125 is locked to the blocking member receiving portion 120.

When the lid 15 is closed, the central retainable member 115c is removably retained by the pair of primary engaging members 110 and the locking mechanism 100 is in an engaged configuration, as illustrated in FIGS. 4C and 4D. When the central retainable member 115c is not retained by the pair of primary engaging members 110, such as when the lid 15 is partially or fully open, as illustrated in FIGS. 4A and 4B, the locking mechanism 100 is in a disengaged configuration.

When the user unlocks and removes the padlock 125 from the receiving bar 130, rotation of the primary engaging members 110 and rotatable member 105 in the releasing direction B is no longer inhibited by abutment of the first projection 135a against the padlock 125. The locking mechanism 100 is thereby free to move from the engaged configuration to a disengaged configuration.

In the reverse process, when the lid 15 is opened by the user, the central retainable member 115c urges the pair of primary engaging members 110 in the releasing direction A. Both the pair of primary engaging members 110 and the rotatable member 105 are free to rotate in the releasing direction A and the central retainable member 115c is thereby released from abutment with the pair of primary engaging members 110. The user may freely open and close the lid 15 until the locking mechanism 100 is returned to the engaged configuration and the padlock 125 is reattached and locked to the receiving bar 130.

Any of the six projections 135 may act as the first projection 135a, and the second projection 135b will inherently be any adjacent projection 135 in the releasing direction B. In this way, additional rotation of the primary engaging members 110 such that a designated first projection 135a which abuts the central retainable member 115 is not required.

The locking mechanism 100 further comprises two secondary engaging members 150, each secondary engaging member 150 fixed to the rotatable member 105 and configured to rotate about the longitudinal axis L of the rotatable member 105. In this embodiment, the secondary engaging members 150 are identical to each primary engaging member 110 of the pair of primary engaging members 110. In a similar manner as outlined above in relation to the central retainable member 115c and the pair of primary engaging members 110, one secondary engaging member 150 is configured to engage the first retainable member 115a when the locking mechanism 100 is in an engaged configuration and the other secondary engagement member 150 is configured to engage the second retainable member 115b when the locking mechanism 100 is in an engaged configuration. The secondary engaging members 150 are also configured to rotate in retaining direction A and in opposing releasing direction B about the longitudinal axis L of the rotatable member 105.

As the primary engaging members 110 and the secondary engaging members 150 are aligned on the rotatable member 105, if rotational motion of only one of the primary engaging members 110 or secondary engaging members 150 is inhibited, then rotational movement is inhibited for all primary engaging members 110 and secondary engaging members 150.

The container body 20 comprises three retainable member guides 155 configured to guide the retainable members 115 into the container body 20 when lid 15 is closed and the pair of primary engaging members 110 are urged into or further into engagement with the retainable members 115. A retainable member guide 155 is located in each of the first end 100a, second end 100b and midpoint between the first end 105a and second end 105b of the locking mechanism 100. Each retainable member guide 155 comprises an aperture, and access to each retainable member 115 is inhibited as, in the engaged configuration, each retainable member 115 is located within the container body 20.

In the following description similar numerals will be used for similar parts of further embodiments of the locking mechanism invention 100.

With reference to FIG. 6, a second embodiment of the locking mechanism 200 is illustrated. In this embodiment, the locking mechanism 200 comprises a mortice lock 260 comprising a deadbolt 265 and the blocking member receiving portion 220 is configured to receive the deadbolt 265. The locking mechanism 200 of the second embodiment omits a receiving bar. The blocking member receiving portion 220 instead comprises a deadbolt receiving aperture 270 configured to receive a deadbolt 265. The deadbolt 265 may be drawn into and out of the deadbolt receiving aperture 270, for example when a user turns the corresponding key in the mortice lock 260.

When the deadbolt 265 is located within the deadbolt receiving aperture 270, rotation of the primary engaging members 210 and rotatable member 205 in the releasing direction is inhibited due to abutment of a projection 235 against the deadbolt 265. In a similar manner to the locking mechanism 100 of the first embodiment of the invention, unauthorised access to the contents of the container is inhibited unless the user has the corresponding key to the mortice lock 260.

The locking mechanism 200 further comprises a guide plate 270 configured to guide the deadbolt 265 into the deadbolt receiving aperture 275.

FIG. 6 illustrates each abutting portion 280 of the six projections 235 comprising a curved depression complementary to the abutting end 240 of the central retainable member. Each abutting portion 280 is located at the base of each projection 235.

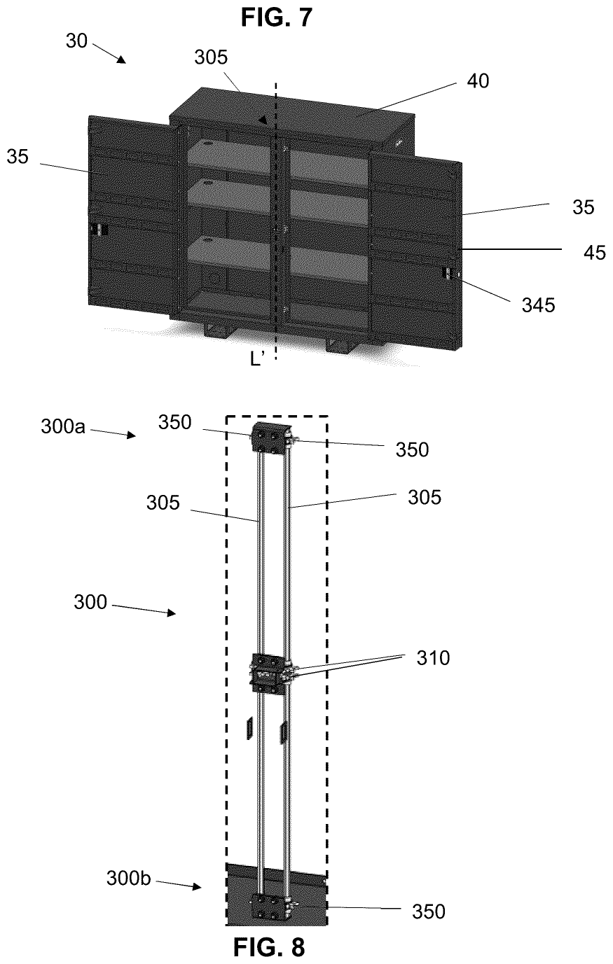

With reference to FIGS. 7-9, a third embodiment of a locking mechanism 300, in accordance with the first aspect of the locking mechanism 300 is fitted to a cabinet 30. In this third embodiment, the locking mechanism 300 is shown in a ‘two door application’ wherein the cabinet 30 comprises two doors 35 and a cabinet body 40 comprising an enclosable volume for storing the contents of the cabinet 30. In this embodiment, the cabinet 30 is a worksite storage cabinet. Both doors 35 are configured to be opened and closed in the standard manner, wherein when each door 35 is closed, a portion of the door 35 abuts the cabinet body 40.

The locking mechanism 300 of the third embodiment is similar to the locking mechanism 100 of the first embodiment. Differences between the two embodiments will be outlined herein. Unless otherwise described the locking mechanism 300 of the third embodiment operates in the manner described in the first embodiment of the locking mechanism invention 100.

The locking mechanism 300 comprises a mirrored pair of rotatable members 305 of equal length arranged parallel to one another. A rotatable member 305 is fixed to the cabinet body 40 at the location where each door 35 abuts the cabinet body 40. The longitudinal axis L′ is parallel to a free edge 45 of each door. In this embodiment, the rotatable member 305 is substantially equal to the length of the free edge 45 of the door 35. The locking mechanism 300 of FIG. 8 is shown in the engaged configuration, wherein both doors 35 of the cabinet 30 are closed. In the engaged configuration, the pair of rotatable members 305 are aligned.

The locking mechanism 300 comprises four secondary engaging members 350, two secondary engaging members 350 located on each rotatable member 305. A secondary engaging member 350 of each rotatable member 305 is located in the first end 300a of the locking mechanism 300. In a similar manner, the other secondary engaging member 350 of each rotatable member 305 is located in the second end 300b of the locking mechanism 300.

The locking mechanism 300 comprises two mirrored pairs of primary engaging members 310, a pair of primary engaging members 310 located on each rotatable member 305. In this way, each rotatable member 305 comprises a pair of primary engaging members 310 and is configured in substantially the same manner as the rotatable member 105 and primary engaging members 110 of the embodiment of FIGS. 1 to 5. Each pair of primary engaging members 310 is located at the midpoint between the first end 300a and second end 300b.

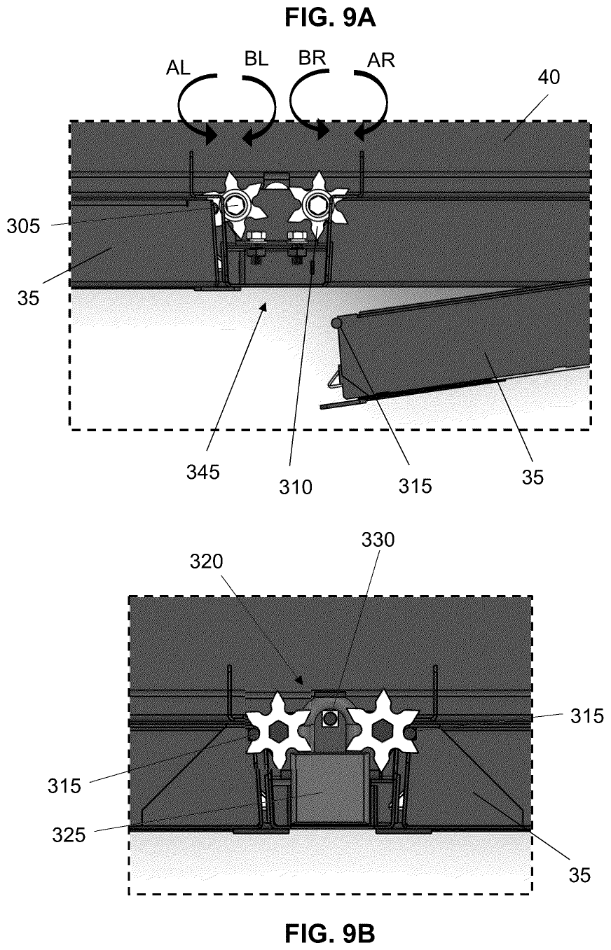

Each door 35 comprises a retainable member 315 comprising a continuous elongate bar. Each elongate bar extends the length of the door 35. The elongate bar is rotational loose to aid retention of the retainable member 315 on the primary engaging members 310. In some embodiments, the elongate bar is not continuous and is only located adjacent each primary engaging member 310 and secondary engaging member 350. In such embodiments, the elongate bar extends to first end 300a and second end 300b of the locking mechanism 300. The primary engaging members 310 are configured to rotate in a retaining direction and in an opposing releasing direction about the longitudinal axis L of the rotatable member 305. In FIGS. 9A and 9B, the left-hand pair of primary engaging members 310 have a retaining direction AL and a releasing direction BL and the right-hand pair of primary engaging members 310 have a retaining direction AR and a releasing direction BR. In the retaining directions AL, AR, the pairs of primary engaging members 110 are urged further into engagement with the retainable member 315. In the releasing directions BL, BR, the pairs of primary engaging members 110 are urged out of engagement with the retainable member 315. In this way, each rotatable member 305 is a mirrored pair of the other.

The blocking member receiving portion 320 comprises a receiving bar 330 with a longitudinal axis perpendicular to the longitudinal axis L′ of the pair of rotatable members 305. In this way, the longitudinal axis L′ of each of the pair of rotatable members 305 is perpendicular to the ground and the receiving bar 330 is parallel to the ground when the cabinet 30 is placed in normal use on the ground.

The user can attach a padlock 325 to the receiving bar 330, such that rotation of the primary engaging members 310 is inhibited by the body of the padlock 325 when the padlock 325 is locked.

Each door 35 comprises a casing configured to encase a portion of the locking mechanism 300 to prevent damage to or interference with the locking mechanism 300. Access to the blocking member receiving portion 320 is provided by a guiding aperture 345 configured to guide the padlock 325 into the correct location on the receiving bar 330. In some embodiments, the plurality of projections are uniformly spaced about the at least one primary engaging member. In some embodiments, the at least one primary engaging member is rowel shaped. Alternatively, the plurality of projections are a plurality of hooks. In some embodiments, the plurality of projections are curved projections. Preferably, the plurality of curved projections are identical and project in either the retaining direction or the releasing direction, when fixed to the rotatable member 305. In some embodiments, the at least one primary engaging member is snowflake shaped. In some embodiments, each projection of the plurality of projections is snail shaped. Namely, each projection comprises a straight edge connected to a curved edge.

Preferably, each projection of the plurality of projections comprises an abutting portion complementary to a portion of the at least one retainable member and configured to abut the at least one retainable member when the locking mechanism is in an engaged configuration. In this way, the abutting portion aids retention of the at least one retainable member in the at least one primary engaging member. In some embodiments, the abutting portion comprises a groove complementary to a blocking member. In some embodiments, the abutting portion comprises a groove complementary to the at least one retainable member. In some embodiments, the abutting portion comprises a flat surface configured to abut a blocking member 425 mounted to the blocking member receiving portion.

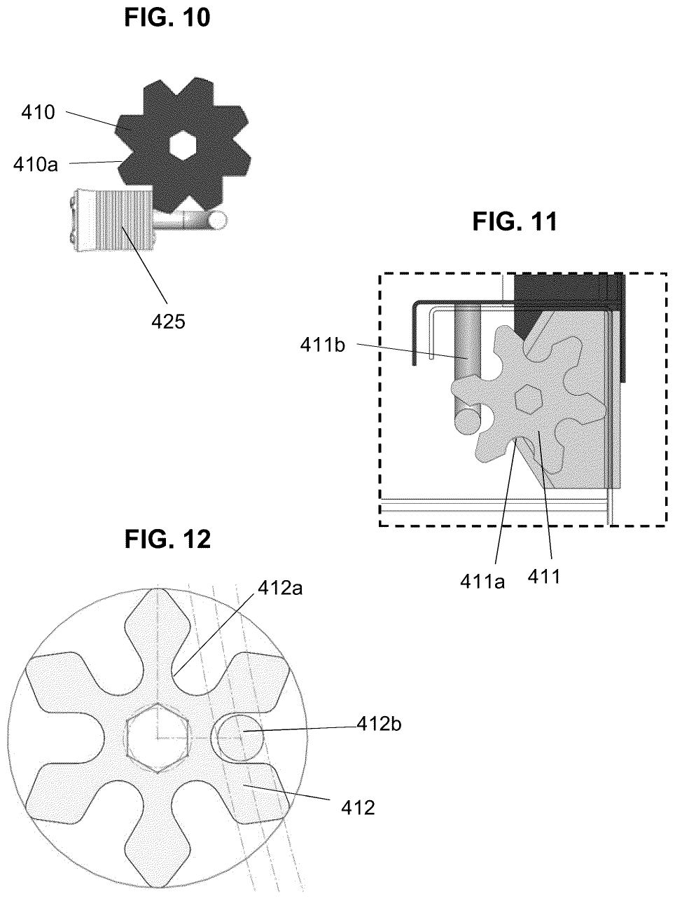

With reference to FIG. 10, there is illustrated an alternative embodiment of a primary engaging member 410 according to the first aspect of the invention. For ease of illustration, the blocking member 425 of each of FIGS. 10, 14 and 15 is assigned the same reference numeral, although it is understood that the blocking member 425 used may be any suitable shape or size blocking member, such as a padlock.

The primary engaging member 410 comprises eight projections and each projection has an abutting portion comprising a flat surface 410a configured to abut the blocking member 425 mounted to the blocking member receiving portion (not pictured).

With reference to FIG. 11, there is illustrated a further embodiment of a primary engaging member 411 according to the first aspect of the invention. The primary engaging member 411 comprises six projections and is snowflake shaped. Each projection has an abutting portion comprising a semi-circular groove 411a complementary to retainable member 411b.

With reference to FIG. 12, there is illustrated a further embodiment of a primary engaging member 412 according to the first aspect of the invention. The primary engaging member 412 of FIG. 12 is similar to the primary engaging member 411 of FIG. 11. The groove 412a comprises a half-stadium shape to aid retention of the retainable member 412b in the groove 412a.

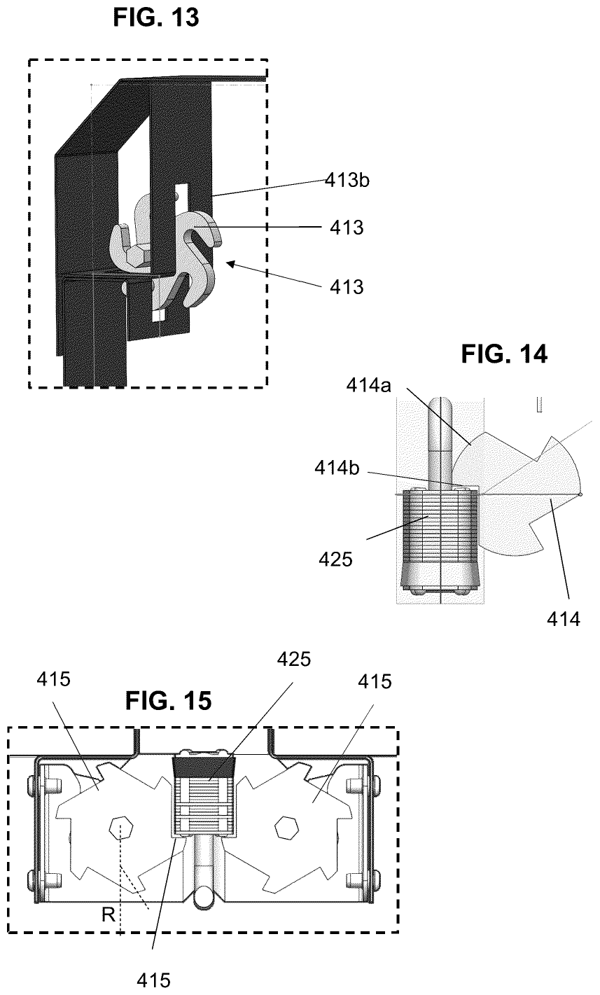

With reference to FIG. 13, there is illustrated a further embodiment of a primary engaging member 413 according to the first aspect of the invention. The five projections are uniformly spaced about the primary engaging member 410 of FIG. 10 and each projection is curved. The curved projections are identical and project in the retaining direction, when fixed to the rotatable member 105, 205, 305. The abutting portion of each projection comprises a slot 413a complementary to the retainable member 413b.

With reference to FIG. 14, there is illustrated a further embodiment of a primary engaging member 414 according to the first aspect of the invention. The three projections are snail shaped. Namely, each projection comprises a leading curved edge 414a which increases in radius from a straight edge 414b which extends along a radius of the primary engaging member 411. The straight edge 414b is comprises a flat surface configured to abut a blocking member 425 mounted to the blocking member receiving portion (not pictured).

With reference to FIG. 15, there is illustrated a further embodiment of two primary engaging members 415 according to the first aspect of the invention, the primary engaging members 415 shown in the ‘two door application’, such as on a cabinet. Each primary engaging member 415 comprises six projections protruding at an angle to the radius R of the primary engaging member 415. Each abutting portion comprises a flat surface 415a configured to abut a blocking member mounted to the blocking member receiving portion.

As may be recognized by those of ordinary skill in the art based on the teachings herein, numerous changes and modifications may be made to the above-described and other embodiments of the present disclosure without departing from the scope of the disclosure. The components of the locking mechanism as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the locking mechanism may include more or fewer components or features than the embodiments as described and illustrated herein. For example, the components and features of FIGS. 1-15 may be used interchangeably and in alternative combinations as would be modified or altered by one of skill in the art. Specifically, locking mechanisms 100, 200 and 300 may be used in alternative combinations as would be modified or altered by one of skill in the art. Accordingly, this detailed description of the currently preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or locking mechanism that “comprises,” “has,” “includes,” or “contains” one or more steps or elements possesses those one or more steps or elements but is not limited to possessing only those one or more steps or elements. Likewise, a step of a method or an element of a locking mechanism that “comprises,” “has,” “includes,” or “contains” one or more features possesses those one or more features, but is not limited to possessing only those one or more features. Furthermore, a locking mechanism or structure that is configured in a certain way is configured in at least that way but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations

What is claimed is:

1. A locking mechanism for a container, the locking mechanism comprising;
a rotatable member configured to rotate about its longitudinal axis;
at least one primary engaging member fixed to the rotatable member and configured to rotate about the longitudinal axis of the rotatable member;
at least one retainable member configured to be retained by the at least one primary engaging member when the locking mechanism is in an engaged configuration; and
a blocking member receiving portion located adjacent the at least one primary engaging member and configured to receive a blocking member when the locking mechanism is in an engaged configuration,
wherein when a blocking member is received in the blocking member receiving portion, rotation of the at least one primary engaging member about the longitudinal axis of the rotatable member is inhibited and the at least one retainable member is retained by the at least one primary engaging member.

2. The locking mechanism of claim 1, wherein the at least one primary engaging member comprises a plurality of projections,
wherein any one of the plurality of projections is configured to retain the at least one retainable member when the locking member is in the engaged configuration.

3. The locking mechanism of claim 2, wherein the at least one primary engaging member is rowel shaped.

4. The locking mechanism of claim 2, wherein the plurality of projections are a plurality of hooks.

5. The locking mechanism of claim 2, wherein each projection of the plurality of projections comprises an abutting portion complementary to a portion of the at least one retainable member and configured to abut the at least one retainable member when the locking mechanism is in an engaged configuration.

6. The locking mechanism of claim 1, wherein the blocking member receiving portion is configured to receive at least one of; a padlock, a combination lock or a deadbolt of a mortice lock.

7. The locking mechanism of claim 6, wherein the blocking member receiving portion comprises a receiving bar with a longitudinal axis parallel to the longitudinal axis of the rotatable member.

8. The locking mechanism of claim 6, wherein the blocking member receiving portion comprises a receiving bar with a longitudinal axis perpendicular to the longitudinal axis of the rotatable member.

9. The locking mechanism of claim 1, wherein the at least one primary engaging member comprises a pair of primary engaging members spaced from each other along the rotatable member.

10. The locking mechanism of claim 8, wherein the spacing of the pair of primary engaging members along the rotatable member is from 5 mm to 20 mm.

11. The locking member of claim 8, wherein the pair of primary engaging members are a mirrored pair.

12. The locking mechanism of claim 1, wherein the at least one retainable member comprises a plurality of retainable members and the locking mechanism further comprises at least one secondary engaging member fixed to the rotatable member and is configured to rotate about the longitudinal axis of the rotatable member, the at least one secondary engaging member is configured to engage the at least one retainable member when the locking mechanism is in an engaged configuration.

13. The locking mechanism of claim 1, wherein the at least one primary engaging member is configured to rotate in a retaining direction and in an opposing releasing direction,
wherein in the retaining direction the at least one primary engaging member is urged further into engagement with the at least one retainable member and in the opposing releasing direction the at least one primary engaging member is urged out of engagement with the at least one retainable member;
wherein when the locking mechanism is moved from a disengaged position to the engaged position, the at least one retainable member urges the at least one primary engaging member in the retaining direction and when the locking mechanism is moved from the engaged position into the disengaged position, the at least one retainable member urges the at least one primary engaging member in the releasing direction.

14. A container comprising the locking mechanism of claim 1.

15. The container of claim 14, wherein the at least one retainable member is located in a first area of the container and the at least one primary engaging member is located in a second area of the container.
